(19) United States
(12) Patent Application Publication
(10) Pub. No.: US 2020/0060332 A1
(43) Pub. Date: Feb. 27, 2020

(54) SMOKE AND VAPOR FILTER DEVICE

(71) Applicant: Trevor J Hulbert, Richmond Hill (CA)

(72) Inventor: Trevor J Hulbert, Richmond Hill (CA)

(21) Appl. No.: 16/549,294

(22) Filed: Aug. 23, 2019

Related U.S. Application Data
(60) Provisional application No. 62/721,755, filed on Aug. 23, 2018.

(51) Int. Cl. A24F 13/00; B01D 46/00; B01D 46/02

(52) U.S. Cl. CPC A24F 13/00; B01D 46/0038; B01D 46/2411; B01D 46/02; B01D 46/0024

(57) ABSTRACT

A reusable smoke and vapor filter device having particular application to be held against the lips of a smoker to receive smoke or vapor that is blown into the device from the lungs of the smoker. The filter device includes a replaceable filter casing within which a disposable compound filter is carried by which a majority of the smoke or vapor is trapped and absorbed. By virtue of the foregoing, the presence of smoke or vapor that would otherwise be exhausted into the atmosphere is avoided. The filter casing can be removed from the reusable filter device and replaced with a new filter casing having a new compound filter without having to discard the entire device. The compound filter carried by the filter casing includes activated carbon granules to absorb the smoke and vapor and an oil soaked material having a fragrance to deodorize the smoke or vapor.

### CROSS-REFERENCE TO RELATED PATENT APPLICATIONS

This application is related to Provisional Patent Application No. 62/721,755 filed Aug. 23, 2018.

### BACKGROUND OF THE INVENTION

### 1. Field of the Invention

This invention relates to a reusable smoke and vapor filter device into which a volume of smoke or vapor is blown from the lungs of a smoker. The reusable filter device includes a replaceable filter casing within which a disposable compound filter is carried so that a majority of the smoke or vapor being blown thereto by the smoker is trapped and absorbed, whereby to advantageously minimize the presence and odor associated with any smoke or vapor that may be exhausted from the filter device into the atmosphere.

### 2. Background Art

Smoking is a habit that is not always appreciated or accepted by those in the vicinity of a smoker. What is more, conventional cigarettes have been replaced by hand-held vaporizers which are known to generate large volumes of vapor. In the cases of cigars, cigarettes, vaporizers, and the like, a potentially noxious exhaust is emitted into the atmosphere from the lungs of the smoker. Consequently, the smoker is often asked to remove himself to an out-of-doors location or to otherwise distance himself from non-smokers who are bothered by the presence and odor of the smoke and vapor.

To avoid some of the problems caused by smokers, filter devices have been introduced into which the smoker blows the smoke and vapor from his lungs. In many cases, the filter device in its entirety is discarded after a few uses to be replaced by an altogether new device. For a frequent smoker, the need, cost and inconvenience of having to constantly find replacement filter devices before being able to smoke among others, especially indoors, are highly disadvantageous.

Accordingly, what would be preferable is an improved and reusable smoke and vapor filter device having a disposable filter that may be conveniently and easily replaced without having to discard the entire device. Also preferable is an efficient filter device that is capable of trapping and absorbing substantially all of the incoming smoke and vapor so as to limit the leakage and exhaust thereof into the atmosphere.

### SUMMARY OF THE INVENTION

In general terms, a reusable smoke and vapor filter device is disclosed into which smoke and vapor is blown from the lungs of a smoker. The filter device includes a disposable compound filter that is enclosed by a filter casing which can be replaced without having to discard the filter device in its entirety. The compound filter is configured to prevent most of the smoke and vapor that is blown thereto from being exhausted into the atmosphere.

The smoke and vapor filter device includes a mouthpiece that is located at one end of the device at which to be connected to a cylindrical mouthpiece support. The mouthpiece support is held in end-to-end alignment with a cylindrical filter base located at the opposite end of the filter device. Detachably connected to and enclosed by the opposing mouthpiece support and the filter base is the replaceable filter casing within which the disposable compound filter is carried. The compound filter has a lower filter that is preferably manufactured from layers of felt that are arranged in concentric circles, and activated carbon granules fill the spaces between the layers. The compound filter also has an upper filter that is preferably manufactured from an absorbent pleated fabric that is soaked in an essential oil having a pleasing fragrance. The upper and lower filters of the compound filter are adapted to trap and absorb most of the smoke being blown thereto by the smoker as well as mask the smell thereof.

When it is desirable to dispose of the compound filter following the use of the smoke and vapor filter device over time, the mouthpiece support and the mouthpiece connected thereto are disconnected from the filter casing and separated from the filter base. The filter casing within which the used compound filter is carried is also disconnected from and lifted out of the filter base. The filter casing and the compound filter therewithin are now discarded, and a new filter casing having a fresh compound filter is substituted therefor. The filter device is reassembled and made ready for use with the new filter casing detachably connected to and enclosed by the mouthpiece support and the filter base located at opposite ends of the device.

### BRIEF DESCRIPTION OF THE DRAWINGS

FIG. 1 is a perspective view showing a preferred embodiment for a smoke and vapor filter device into which smoke or vapor is blown;

FIG. 2 is an exploded view of the smoke and vapor filter device of FIG. 1;

FIGS. 3 and 4 are cross-sectional views of the smoke and vapor filter device shown in FIG. 2;

FIG. 5 is a cross-section of the smoke and vapor filter device of FIG. 1; and

FIG. 6 is another exploded view of the smoke and vapor filter device.

### DESCRIPTION OF THE PREFERRED EMBODIMENT

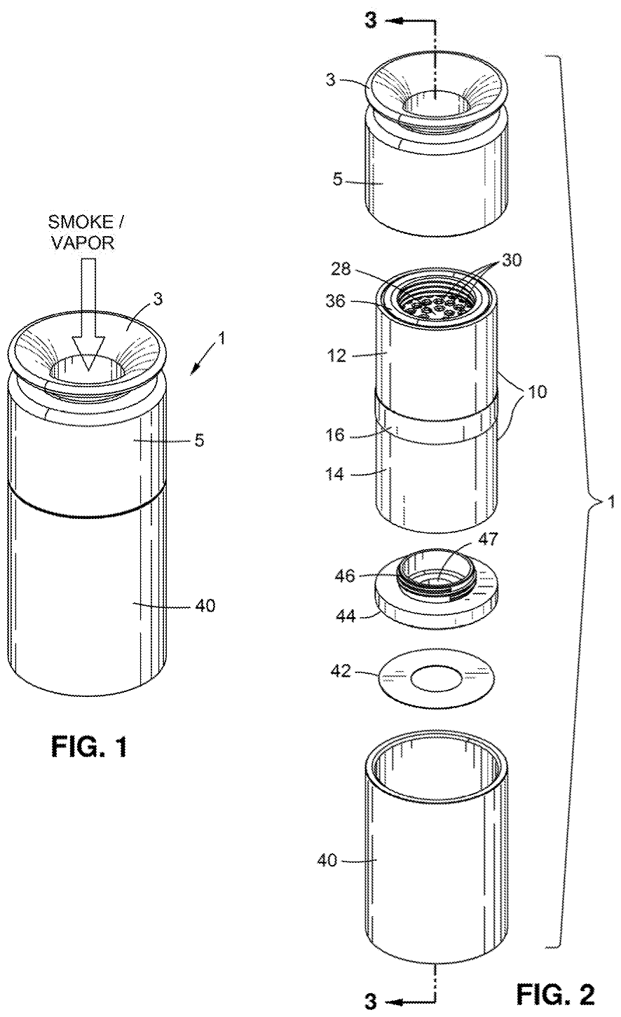

Referring concurrently to FIGS. 1-6 of the drawings, there is shown a preferred embodiment for a resusable smoke and vapor filter device 1 to be used by one smoking a cigarette or a cigar, or the like, or using a vaporizer or any other smoke or vapor generating means of the kind that is typically held in contact with a smoker's lips so that a supply of smoke or vapor is inhaled from such device into the lungs of the user. As will be described in greater detail hereinafter, the filter device 1 herein disclosed is adapted to trap and absorb a majority of the smoke or vapor that is exhaled from the lungs of the smoker to avoid the presence and odor of the smoke or vapor that would otherwise be exhausted directly into the atmosphere had the filter device of this invention not been used.

Although the smoke and vapor filter 1 will be used primarily within an indoors environment, the actual location of its use should not be considered as a limitation of this invention. Moreover, the teachings of this invention as a filter device are also applicable to trapping and absorbing smoke and vapor supplied thereto from sources other than the smoking articles mentioned above that generate smoke or vapor of the kind that is inhaled into and exhausted from the lungs of the user.

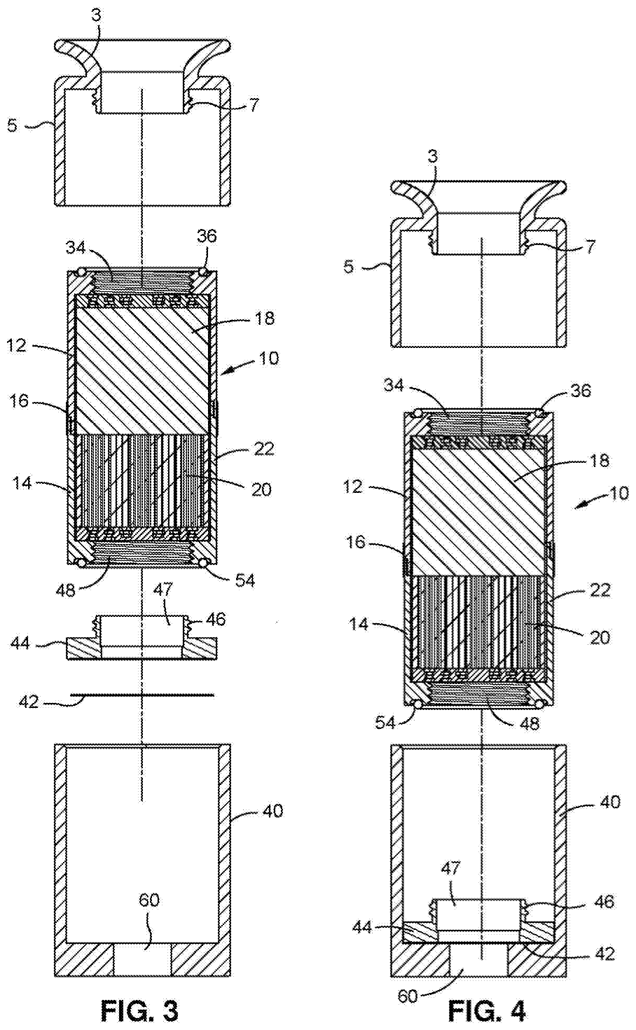

The smoke and vapor filter device 1 includes a mouthpiece 3 that is shaped so as to be placed comfortably against the lips of a smoker. The mouthpiece 3 is coextensively connected to a hollow cylindrical mouthpiece support 5 that is located at one end of the device 1. As is best shown in FIGS. 3 and 4, the mouthpiece support 5 has a set of threads 7 extending therearound. Thus, the mouthpiece 3 communicates with the mouthpiece support 5 so that smoke or vapor that has been inhaled by the smoker is exhaled into the filter device 1 by way of the mouthpiece 3 and its support 5.

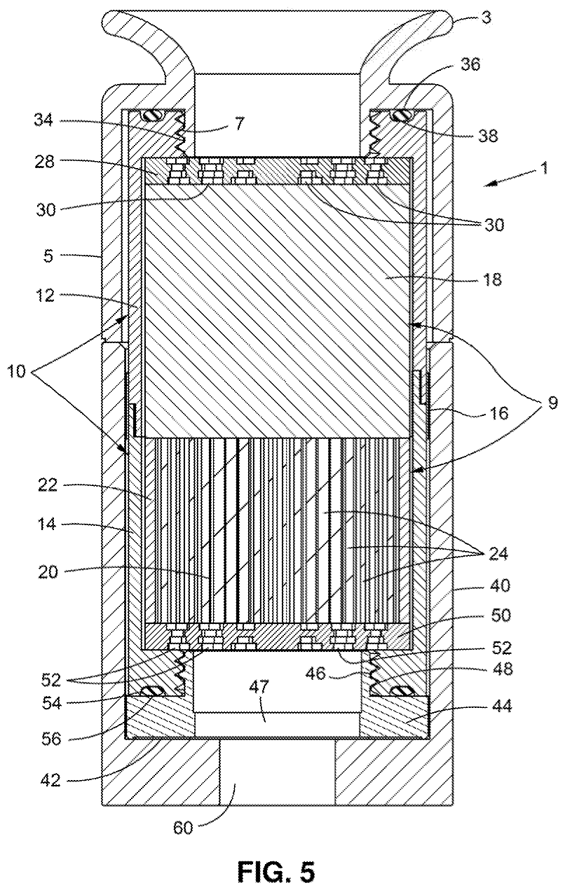

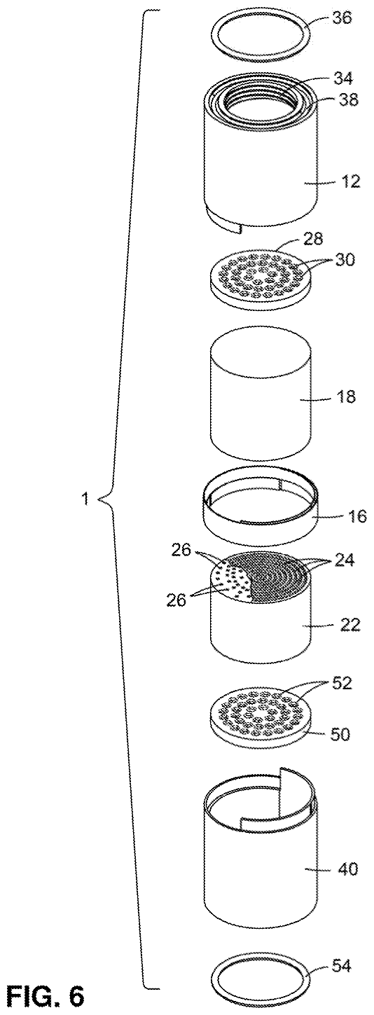

The smoke or vapor that is supplied to the device 1 at the mouthpiece 3 is blown from the lungs of the user into a disposable compound filter 9 (best shown in FIG. 5). The compound filter 9 is surrounded by and enclosed within a replaceable cylindrical filter casing 10 (also best shown in FIG. 5). As is best shown in FIG. 6, the filter casing 10 has an upper half 12 and a lower half 14 that are held together one above the other by means of an adhesive-backed band 16 that surrounds the interface therebetween.

As an important feature of this invention by which to reduce the emission of exhaust from the smoke and vapor filter device 1 and thereby minimize the presence and odor that would be created by such exhaust, the compound filter 9 that is surrounded by the filter casing 10 includes upper and lower filters 18 and 20 that are stacked one above the other. Referring specifically to FIG. 5 of the drawings, the lower filter 20 is shown carried by a filter cartridge 22. The upper filter 18 of the disposable compound filter 9 is received within the upper half 12 of the replaceable filter casing 10, and the filter cartridge 22 in which the lower filter 20 is carried is received within the lower half 14 of the filter casing 10.

By way of example only, the upper filter 18 which lies closest to the mouthpiece 3 is preferably manufactured from an absorbent pleated fabric and sometimes referred to as a hepa filter. The lower filter 20 is manufactured from successive layers of felt (designated 24 in FIG. 6) that are arranged in concentric circles of different diameter. The pleated fabric of the upper filter 18 is soaked in an essential oil (e.g., lavender or vanilla) having a pleasing fragrance to mask the odor of the smoke or vapor being blown into the smoke and vapor filter device 1. Activated carbon granules (designated 26 in FIG. 6) are loaded into the lower filter 20 to fill the spaces between the successive concentrically arranged layers 24 thereof. By virtue of the upper and lower filters 18 and 20 of the disposable compound filter 10 described above that are stacked one above the other within the replaceable filter casing 10, most of the smoke and vapor that is blown by the smoker into the smoke and vapor device 1 by way of the mouthpiece 3 will be trapped and absorbed and deodorized by filters 18 and 20 and thereby prevented from being exhausted into the atmosphere.

To this end, and continuing to refer to FIG. 5, an upper mesh screen 28 having a plurality of orifices 30 formed therethrough (best shown in FIG. 6) is located in the filter device 1 between the mouthpiece 3 and the upper filter 18 of the compound filter 9. Thus, the smoke or vapor being blown towards the compound filter 9 by way of the mouthpiece 3 is forced through the plurality of orifices 30 formed in the upper mesh screen 28, whereby any particular matter will be blocked by the mesh screen. As is best shown in FIGS. 3 and 4, the upper mesh screen 28 is positioned immediately below a threaded mouthpiece coupling opening 34 that is formed through the top of the upper half 12 of the filter casing 10.

In the assembled configuration of the filter device 1 shown in FIG. 5 with the disposable compound filter 9 surrounded by the replaceable filter casing 10, the upper half 12 of casing 10 is moved into and through the hollow cylindrical mouthpiece support 5. The threaded end 7 of the mouthpiece 3 is then rotated into mating engagement with the threaded mouthpiece coupling opening 34 formed through the top of the upper half 12 of the filter casing 10. Accordingly, the mouthpiece support 5 is detachably connected to the top of the filter casing 10, such that the mouthpiece 3 is held in axial alignment with both the orifices 30 through the upper mesh screen 28 that lies below the mouthpiece and the upper filter 18 of the compound filter 9 that lies below mesh screen 28.

A first resilient (e.g., rubber) O-ring (designated 36 in FIG. 6) is located within an O-ring groove (designated 38 in FIG. 5) that runs around the top of the upper half 12 of the filter casing 10. As is best shown in FIG. 5, when the mouthpiece support 5 is detachably connected to the filter casing 10 in the manner just described, the O-ring 36 is compressed between the mouthpiece support 5 and the top of the upper half 12 of filter casing 10. The O-ring 36 advantageously provides a seal to minimize the escape into the atmosphere of the smoke and vapor that is blown towards the compound filter 9 by way of the mouthpiece 3 of the smoke and vapor filter device 1.

As is best shown in FIGS. 3 and 4, the cylindrical mouthpiece support 5 at the top of the smoke and vapor filter device 1 is aligned end-to-end with a filter base 40. The filter base 40 has a cylindrical body that lies at the bottom of device 1 opposite the mouthpiece support 5 so that the filter casing 10 is enclosed by and extends between the mouthpiece support 5 and the filter base 40. The filter base 40 has an open top and a closed bottom. Prior to this alignment, a thin bonding ring 42 (best shown in FIG. 2) that is covered with an adhesive on both sides is attached to the closed bottom of the cylindrical filter base 40 to lie flush thereagainst. A disc-like base adapter 44 having a threaded collar 46 standing upwardly therefrom and surrounding a central pass-through 47 is seated on top of the bonding ring 42 so as to be adhesively attached by the bonding ring to the bottom of the cylindrical filter base 40. With the base adapter 44 held in place by the adhesive of the bonding ring 42 against the bottom of the filter base 40, the lower half 14 of the filter casing 10 is detachably connected to (i.e., rotated into mating engagement with) the threaded collar 46 of adapter 44 so as to be removably received within and surrounded by the filter base 40.

A second resilient (e.g., rubber) O-ring (designated 54 in FIG. 6) is located within an O-ring groove (designated 56 in FIG. 5) that runs around the bottom of the lower half 14 of the filter casing 10. With the lower half 14 of filter casing 10 detachably connected to the threaded collar 46 of the base adapter 44 in the manner just described, the second O-ring 54 is compressed between the lower half 14 of the filter casing 10 and the base adapter 44. The second O-ring 54 advantageously provides an additional seal (together with the first O-ring 36) to further minimize the escape from the filter device 1 of smoke and vapor into the atmosphere. In this regard, the seals established by the first and second O-rings 36 and 54 provide the smoke and vapor filter device 1 of this invention with an advantage over other filter devices which are known to leak smoke and vapor into the atmosphere.

FIG. 5 of the drawings shows the smoke and vapor filter device 1 in its assembled ready to use configuration with the cylindrical mouthpiece support 5 lying above the cylindrical filter base 40 so as to surround and enclose the filter casing 10 therewithin. Similar to the threaded mouthpiece coupling opening 34 (of FIGS. 3 and 4) that is formed through the top of the upper half 12 of the filter casing 10, a threaded adapter coupling opening 48 (also shown in FIGS. 3 and 4) is formed through the bottom of the lower half 14 of casing 10.

The lower half 14 of the replaceable filter casing 10 is moved into and through the hollow cylindrical filter base 40 (best illustrated in FIG. 4). The threaded adapter coupling opening 48 formed through the bottom of the lower half 14 of filter casing 10 is then rotated into mating engagement with the threaded collar 46 that stands upwardly from the base adapter 44. Accordingly, the threaded upper and lower halves 12 and 14 of the filter casing 10 are respectively and detachably connected to the mouthpiece support 5 at the threads 7 of mouthpiece 3 and to the filter base 40 at the threads 46 of the base adapter 44, whereby the mouthpiece support 5 and the filter base 40 are held in place end-to-end one above the other.

When the filter device 1 is assembled as shown in FIG. 5, a lower mesh screen 50 having a plurality of orifices 52 formed therethrough (best shown in FIG. 6) is located between the base adapter 44 and the filter cartridge 22 that surrounds lower filter 20 of the compound filter 9. Thus, any smoke or vapor that is blown completely through the compound filter 9 by way of the mouthpiece 3 is forced through the plurality of orifices 52 formed in the lower mesh screen 50, whereby any particulate matter that still remains in the exhaust will be blocked by the mesh screen.

That is, an exhaust exit opening 60 (best shown in FIGS. 3 and 4) is formed through the closed bottom of the filter base 40. In the assembled configuration of FIG. 5, the exhaust exit opening 60 is axially aligned with the mouthpiece 3, the disposable compound filter 9 surrounded by the replaceable filter casing 10, the orifices 30 and 52 formed through the upper and lower mesh screens 28 and 50, and the pass-through 47 of the disc-like base adapter 44. Thus, to relieve excessive pressure that may be created as a consequence of a large volume of smoke or vapor being rapidly blown into the mouthpiece 3, some of the smoke or vapor is permitted to escape the filter device 1 by way of the exhaust exit opening 60. However, it is to be understood that the majority of the smoke and vapor being blown into the device 1 at mouthpiece 3 will be trapped within and absorbed by the compound filter 9 and thereby prevented from entering the atmosphere.

From time-to-time, and depending upon the frequency of its use, it may be necessary to clean the reusable filter device 1 and change the disposable compound filter 9 that is surrounded by the replaceable filter casing 10 lying within the filter device 1. In this event, the mouthpiece support 5 is first separated from the filter base 40 by rotating the threaded mouthpiece 3 out of its engagement to the threaded mouthpiece coupling opening 34 at the top of filter casing 10. The bottom of the filter casing 10 is then rotated out of its engagement to the threaded base adapter 44 lying at the bottom of the filter base 40. The filter casing 10 is now simply lifted upwardly and outwardly from the filter base 40 and discarded. A new filter casing carrying a fresh compound filter is dropped into the filter base 40, and the smoke and filter device 1 is reassembled in the manner previously described but without the disadvantage of having to dispose of the entire device.

1. A filter device having first and opposite ends and into which a supply of smoke or vapor is blown, said filter device comprising:
a smoke and vapor inlet located at the first end of said filter device for receipt of the supply of smoke or vapor;
a filter base located at the opposite end of said filter device; and
a disposable filter casing having first and opposite ends and within which a smoke and vapor filter is carried, said smoke and vapor inlet being detachably connected to the first end of said disposable filter casing and said filter base being detachably connected to the opposite end of said disposable filter casing, whereby said disposable filter casing is connected between said smoke and vapor inlet and said filter base so that said smoke and vapor filter carried by said disposable filter casing receives the supply of smoke or vapor by way of said inlet,
said smoke and vapor inlet and said filter base being detachable from the respective first and opposite ends of said disposable filter casing in order for said disposable filter casing to be removed from said filter device and replaced by a different disposable filter casing.

2. The filter device recited in claim 1, wherein said smoke and vapor filter carried by said disposable filter casing includes activated carbon granules to absorb at least some of the supply of smoke or vapor supplied thereto by way of said smoke and vapor inlet.

3. The filter device recited in claim 2, wherein said smoke and vapor filter carried by said disposable filter casing also includes layers of material arranged relative to one another so that a space is located between successive ones of said layers, said activated carbon granules being located within the spaces located between said layers.

4. The filter device recited in claim 3, wherein the layers of material of said smoke and vapor filter carried by said disposable filter casing are arranged relative to one another in concentric circles.

5. The filter device recited in claim 2, wherein said smoke and vapor filter carried by said disposable filter casing also includes an absorbent material that is soaked with oil having a fragrance, said oil soaked absorbent material and said activated carbon granules lying one above the other within said disposable filter casing.

6. The filter device recited in claim 1, wherein each of the first and the opposite ends of said disposable filter casing has a first set of screw threads extending therearound and each of said smoke and vapor inlet and said filter base has a second set of screw threads extending therearound, the smoke and vapor inlet being detachably connected to the first end of said disposable filter casing and the filter base being detachably connected to the opposite end of said disposable filter casing at the respective first and second sets of screw threads thereof.

7. The filter device recited in claim 1, further comprising a first O-ring seal located between said smoke and vapor inlet and the first end of said disposable filter casing and a second O-ring seal located between said filter base and the opposite end of said disposable filter casing.

8. The filter device recited in claim 1, wherein said smoke and vapor inlet located at the first end of said filter device is a mouthpiece configured for use against the lips of a smoker from whose lungs the supply of smoke or vapor is capable of being blown into said mouthpiece.

9. The filter device recited in claim 8, wherein said mouthpiece is connected to a cylindrical mouthpiece support and said filter base has a cylindrical body, said cylindrical mouthpiece support and said cylindrical body being aligned end-to-end one another such that said filter casing is removably received between and enclosed by said end-to-end aligned cylindrical mouthpiece support and the cylindrical body of said filter base.

10. The filter device recited in claim 1, further comprising a screen having a plurality of orifices formed therethrough, said screen being located within said disposable filter casing and lying between said smoke and vapor filter carried by said filter casing and said smoke and vapor inlet, the plurality of orifices formed through said screen being sized to trap particulate matter in the smoke or vapor that is supplied to said smoke and vapor filter by way of said smoke and vapor inlet.
